(19) United States
(12) Patent Application Publication
(10) Pub. No.: US 2008/0092303 A1
(43) Pub. Date: Apr. 24, 2008

(54) MULTI-PURPOSE CONTAINER OPENER

(76) Inventor: Robert Mazur, Canton, MI (US)

Correspondence Address: BUTZEL LONG, 350 SOUTH MAIN STREET, SUITE 300, ANN ARBOR, MI, 48104, US

(21) Appl. No.: 11/872,206

(22) Filed: Oct. 15, 2007

Related U.S. Application Data
(60) Provisional application No. 60/851,978, filed on Oct. 14, 2006.

(51) Int. Cl. B25F 1/00

(52) U.S. Cl. 7/151; 206/232; 206/457; 206/531

(57) ABSTRACT

A multi-purpose device for opening the closures of a variety of containers which includes a main body having a substantially flat top surface and a substantially flat bottom surface with a peripheral wall extending downward from the substantially bottom surface of the main body. An elastomeric sheet is attached to the substantially bottom surface of the main body and can be used to press against and twist a cap or lid off a container. A display area having a peripheral upstanding rim is centrally located on the flat top surface of the main body for receiving printed material such as a photograph, drawing or textual material for display purposes. A smaller portion is attached to the main body portion, which smaller portion is substantially coplanar with the main body portion and includes at least one small rigid projection.

### RELATED APPLICATION

The present application is based upon U.S. Provisional Patent Application Ser. No. 60/851,978, filed Oct. 14, 2006 to which priority is claimed under 35 U.S.C. §120 and of which the entire specification is hereby expressly incorporated by reference.

### TECHNICAL FIELD

The present invention relates to devices for opening various containers. More particularly, the present invention relates to a decorative, multi-purpose device that can be used to breach and/or open a variety of containers to access the contents thereof.

### BACKGROUND ART

Containers used to retain various consumer products are often purposefully designed to be difficult to open in order to prevent or deter tampering with the containers' contents. For example, cartons, such as, but not limited to, cardboard or corrugated paper food containers may be sealed using an FDA approved adhesive. Food containers may also include an inner foil pack that must be opened by breaking an adhesive or heat-sealed bond. Bottles containing beverages may include twist-off caps that require breaking a safety seal before the cap can be removed, and metal beverage containers may include push- or pull-tabs of the type typically found on soft drink cans. Medicine or pharmaceutical containers may include safety caps that have to be pried off the containers or may require the performance of several motions simultaneously, e.g., pushing down and twisting, in order to remove the cap. These containers may also include safety seals that must be removed before the container's contents may be accessed. Other forms of medicine or pharmaceutical containers may include adhesively bonded or heat-sealed foil backings bonded to a flexible plastic container. These types of containers include, but are not limited to, blister packs. While the described container features, as well as and other similar features not mentioned, serve useful purposes, their presence may severely inhibit access to a container's contents.

The present invention provides a decorative, multi-purpose device that can be used to breach and/or open a variety of containers to access the contents thereof.

### DISCLOSURE OF THE INVENTION

According to various features, characteristics and embodiments of the present invention which will become apparent as the description thereof proceeds, the present invention provides a multi-purpose device for opening the closures of a variety of containers which comprises:

a main body that includes a substantially flat top surface and a substantially flat bottom surface;

a peripheral wall extending downward from the substantially bottom surface of the main body;

an elastomeric sheet attached to the substantially bottom surface of the main body; and

a display area centrally located on the flat top surface of the main body for receiving printed material for display purposes, said display area having a peripheral upstanding rim.

The present invention further provides a multi-purpose device for opening the closures of a variety of containers which comprises:

a main body that includes a substantially flat top surface and a substantially flat bottom surface;

a peripheral wall extending downward from the substantially bottom surface of the main body;

an elastomeric sheet attached to the substantially bottom surface of the main body;

a display area centrally located on the flat top surface of the main body for receiving printed material for display purposes, said display area having a peripheral upstanding rim; and

a smaller portion attached to the main body portion, which smaller portion is substantially coplanar with the main body portion and includes at least one small rigid projection.

### BRIEF DESCRIPTION OF DRAWINGS

The present invention will be described with reference to the attached drawings which are given as non-limiting examples only, in which:

FIG. 1 is a planar top view of a multi-purpose device according to one embodiment of the present invention.

FIG. 2 is a planar bottom view of the multi-purpose device of FIG. 1.

FIG. 3 is cross-sectional view of the multi-purpose device taken along sectional lines III-III in FIG. 1.

FIG. 4 is an exploded perspective view which depicts one manner of applying a photograph to the display surface of the device of the present invention.

FIG. 5 is an exploded view that depicts a pill management attachment that can be coupled to the device.

FIG. 6 is a perspective view of another embodiment of the device of the present invention.

FIG. 7 is a cross-sectional view of the device of FIG. 6.

### BEST MODE FOR CARRYING OUT THE INVENTION

The present invention is directed to a decorative, multi-purpose device that can be used to breach and/or open a variety of containers to access the contents thereof.

The device of the present invention is a hand-held device that includes a body that supports a variety of tools adapted for opening a variety of different types of containers and accessing the contents of such containers. The various tools include tools for piercing, scoring, or cutting portions of containers, including safety seals associated with containers. The body may also support a gripping device that facilitates opening various types and sizes of containers that are closed by a top or cap.

According to one embodiment, the device of the present invention is configured so that a photograph, drawing, etc. can be attached or applied to the body thereof so as to allow the device to be decorative for purposes of displaying the device on a surface, including on a vertical surface by means of a magnet, hook, etc.

In an alternative embodiment, the device of the present invention can support or be coupled to an attachment that includes one or more pockets and a pill splitting tool and one or more compartments or pockets for capturing pieces of split pills or tablets.

The multi-purpose device of the present invention is made from a combination of rigid materials and non-rigid or resilient materials. Examples of rigid materials that can be used and incorporated into the multi-purpose device of the present invention include moldable plastic materials, metals that can be molded, cast or machined, and other suitable rigid materials. Examples of non-rigid, resilient materials include materials such as such as rubber materials, blends of plastics and elastomers and other materials that provide a frictional gripping feature as will be understood as the description thereof proceeds.

According to one embodiment, the multi-purpose device of the present invention is configured to be in the shape of a cat, a dog, a rabbit, or other domestic and non-domestic animals. In further embodiments, the multi-purpose device of the present invention can be configured to have any desired shape, including geometric or non-geometric shapes.

The present invention will be hereafter described with reference to the attached drawings, which depict, for descriptive purposes, an embodiment of the present invention which is configured in the shape of a cat. It is nevertheless to be understood, as discussed above, that the multi-purpose device of the present invention can be configured to be in the shape of any animal such as a cat, dog, rabbit, etc, or can have any desired shape, including geometric or non-geometric shapes. It is believed that the description of the multi-purpose device of the present invention made in reference to the shape of a cat will enable those skilled in the art to configure the multi-purpose device in other shape or shapes.

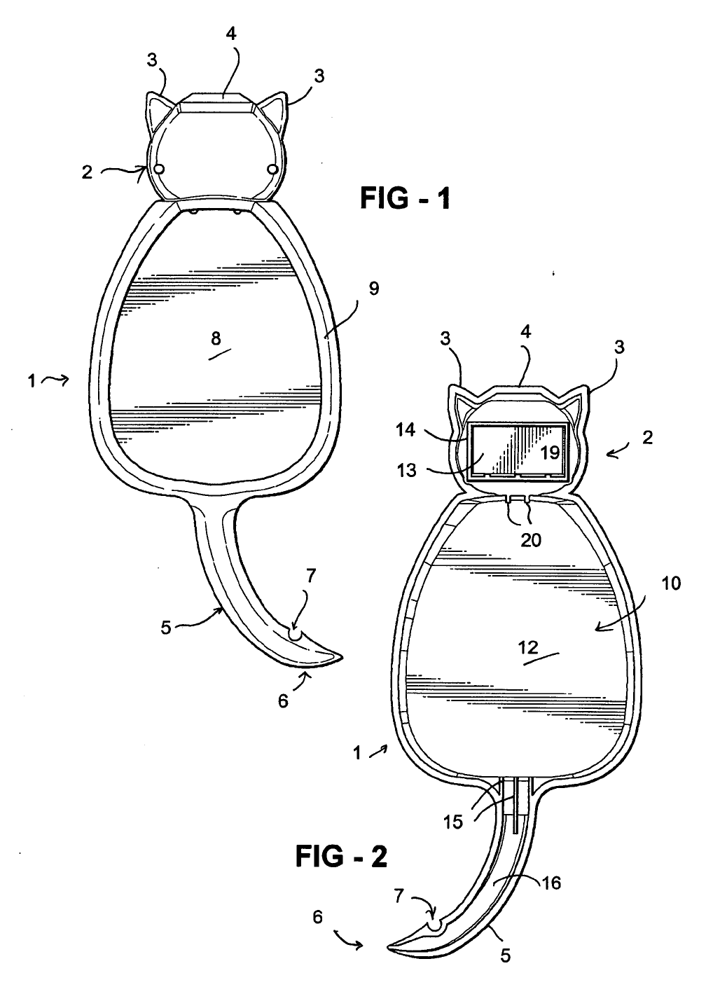

FIG. 1 is a planar top view of a multi-purpose device according to one embodiment of the present invention. The multi-purpose device shown in FIG. 1 is has a main body portion 1 and a smaller portion 2 that is connected with or coupled to the main body portion 1. In the depicted embodiment the main body portion 1 is configured to resemble the body of a cat and the smaller portion 2 is configured to resemble the head of a cat. The smaller portion 2 includes two projections 3 that extend outward and are, in this embodiment, configured to resemble the ears of a cat. Between the two projections 3 one or more small rigid prying projections 4 (one shown) extend outward for purposes of prying closures from containers as discussed in more detail below. A narrow, curved structure 5 extends from the main body portion 1 at an opposite side from the smaller portion 2. In the illustrative embodiment, the narrow curved structure 5 is configured to generally represent the tail of a cat. A hook 6 is formed at or near the end of the narrow, curved structure by providing a notched area 7 in the narrow, curved structure 5. As discussed below, the narrow, curved structure 5 can be used for a number of purposes, including piercing, puncturing, hooking, etc.

The top portion of the central area 8 of the main body portion 1 is substantially flat and can have a peripheral raised rim 9 as shown. This area can be used as a display area. In this regard, as discussed in more detail below, a photograph, drawing or some other graphical or textural material can be attached or applied to the central area 8. This allows the device of the present invention to serve a decorative purpose by, for example, by displaying a favorite photograph, drawing or some other graphical or textural material when not in use.

FIG. 2 is a planar bottom view of the multi-purpose device of FIG. 1. Has shown in FIG. 2 the bottom or underside of the multi-purpose device includes a recessed area 10 that corresponds to the main body portion 1 which has a peripheral wall 11. A layer or sheet or pad of a non-rigid or resilient material such as an elastomeric material or a rubber material 12 is applied or fixed to the bottom of recessed area 10. This rubber material 12 increases the friction that can be applied to the top of a container cap when the device of the present invention is pressed down against a container cap. This will allow simultaneous pressing and rotation of the device to thereby press and rotate the container cap with respect to the container and remove the same from the container. This is particularly suitable for removing the type of medicine container caps that require simultaneously pressing down and rotating the caps. As can be understood, any structure or elemental feature that provides for increasing the necessary friction can be used, including discrete areas of a non-rigid or resilient material such as a rubber material (as opposed to a continuous sheet or layer). In other embodiments, the a non-rigid or resilient material could be omitted and the bottom surface of the recessed area could be formed with protrusions, grooves, teeth or other structures that provide for an increase in the frictional force.

The smaller portion 2 of the device is configured to receive a magnet 13 that can be use to secure the device on to a vertical metal surface such a refrigerator, stove, vent hood, etc. According to one embodiment, the magnet 13 can be received as secured, e.g. glued, into a walled recess 14 formed on the bottom side of the smaller portion 2.

As shown in FIG. 2, the narrow curved structure 5 includes some reinforcing structures 15 near the base thereof. In addition, in order to reduce weight, the narrow curved structure 5 has a recessed central portion 16.

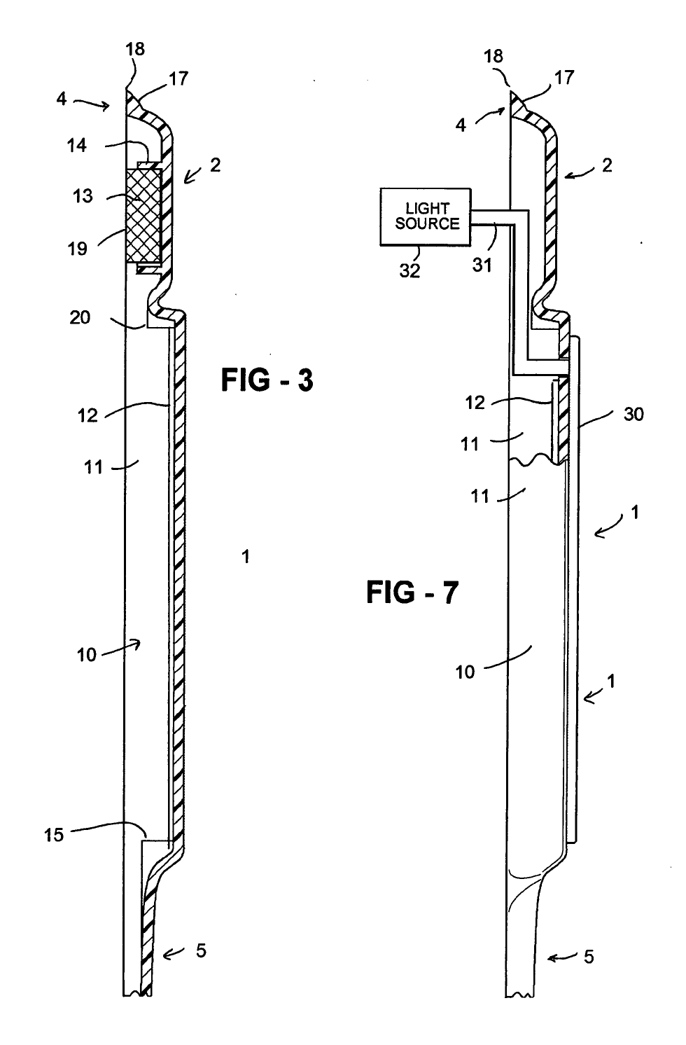

FIG. 3 is cross-sectional view of the multi-purpose device taken along sectional lines III-III in FIG. 1. As shown, the recessed area 10 is defined by a peripheral wall 11 that extends downward from the central area 8 of the main body portion 1. Further, as shown, the small rigid prying projection(s) 4 has an inclined upper surface 17 that forms a narrow leading edge 18 that can be used to pry objects such as snap-on container lids or caps. Also shown in FIG. 3 is the walled recess 14 formed on the bottom side of the smaller portion 2 into which the magnet 13 is received and secured. The lower surface 19 of the magnet 13 should be at least coplanar with the bottom surface of peripheral wall 11 as illustrated or extend slightly beyond the bottom surface of peripheral wall 11 so as to allow the lower surface 19 of the magnet 13 to be exposed for securing the device onto a metal surface. The reinforcing structure(s) 15 near the base of the narrow curved structure 5 is also shown in FIG. 3, together with a reinforcing structure 20 near the junction of the main body portion 1 and the smaller portion 2. Those skilled in the art would understand that other configurations and/or reinforcing structures could be used to provide mechanical strength while reducing material for weight reduction purposes.

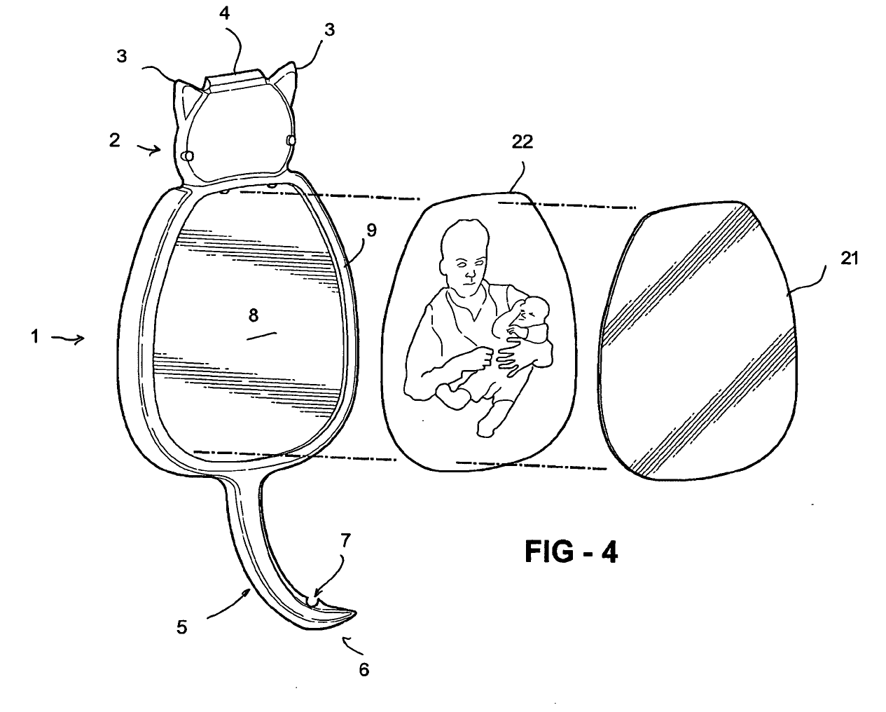

FIG. 4 is an exploded perspective view which depicts one manner of applying a photograph to the display surface of the device of the present invention. As discussed above, the top portion of the central area 8 of the main body portion 1 can be used as a display area. In order to display a photograph, drawing or some other graphical or textural material, such can be attached or applied to the central area 8 in a number of manners. In the illustrated embodiment, a transparent sheet 21 can be placed over a photograph 22 that is to be attached or applied to the central area 8. As illustrated, the photograph 22 is shaped (e.g. cut to shape) to correspond to the shape of the central area 8. Next, the photograph 22 is placed in the central area 8 and the transparent sheet 21 is secured over the central area 8. In order to secure the transparent sheet over the central area 8 the edges of the transparent sheet 21 can be formed with tabs or other structural features (not shown) that engage and interlock with corresponding recesses or other cooperating structural features provided in the peripheral raised rim 9 or other peripheral portion of the central area 8. Alternatively the peripheral raised rim 9 can include an undercut area or areas and/or inwardly directed projections that the transparent sheet 21 can slide under. According to further embodiments, the photograph, drawing or some other graphical or textural material, such can be attached or applied to the central area 8 by means of paste or glue or double- or single-sided tape and the transparent sheet 21 can be used omitted if desired. A further embodiment of the present invention involves providing a template by which one can mark a photograph, drawing or some other graphical or textural material, so as to cut the same in a shape that corresponds to the central area 8. It is also possible to provide a similar display on the top surface of the smaller portion 2 if desired.

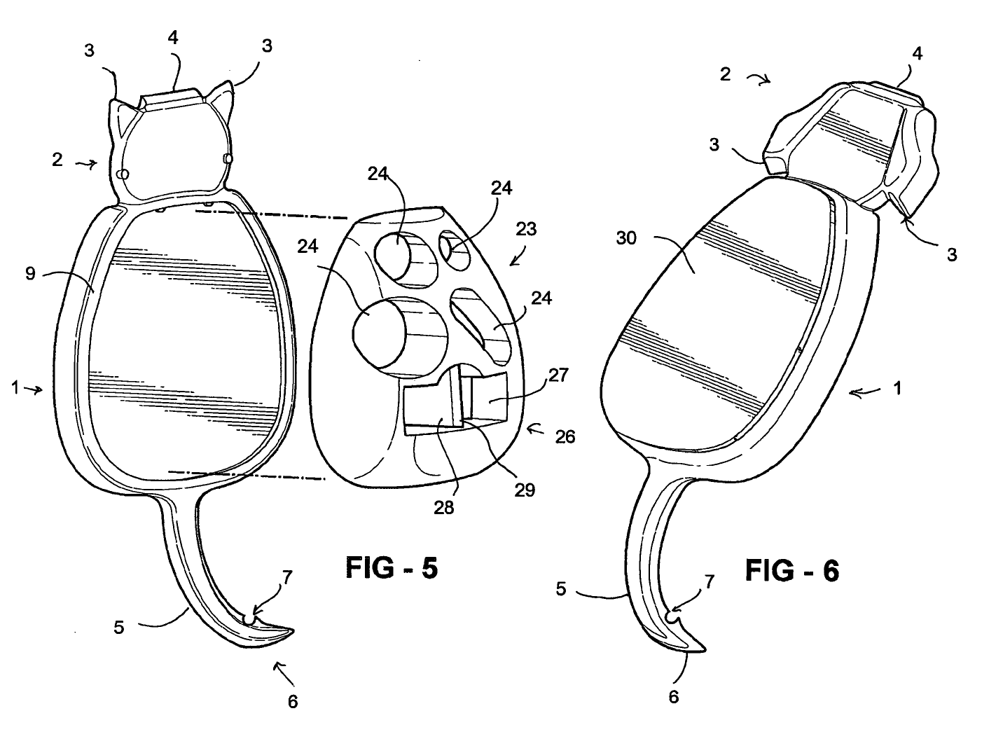

FIG. 5 is an exploded view that depicts a pill management attachment that can be coupled to the device. The pill management attachment 23 can be configured to snap-fit, removably couple in some other mechanical manner or adhere by chemical means such as an adhesive or magnetic force. The illustrated pill management attachment 23 includes variously sized pockets 24 which extend downwardly from the curved surface 25 and terminate at closed bottom surfaces. As shown, the pockets 24 may be configured in a variety of shapes. One or more pockets 24 can be configured and used by placing the back portion of a pill container such as a blister pack over the opening of the pocket 24 and pushing the pill from the opposite side through the foil backing of the container and into the pocket 24. The illustrated attachment can also include a pill splitter 26, in the shape of a pocket 27 that is divided into two compartments by an upwardly extending wall 28. The wall 28 defines a pointed upper edge portion 29. When a pill is pressed against the upper edge 29, the pill will break into two or more pieces which pieces will fall into the compartments of pocket 27.

According to other embodiments of the present invention, other attachments can be coupled to the device. For example, a compartmented daily pill box can be coupled to the device in a similar manner as the pill management attachment noted above. Other types of attachments include a pad of paper, a dry erasable white board, a timer, a pill carrier or an alarm.

FIG. 6 is a perspective view of another embodiment of the device of the present invention. FIG. 7 is a cross-sectional view of the device of FIG. 6. In the embodiment of FIGS. 6 and 7, the central area 8 of the device is provided with a layer or sheet of material 30 such as a transparent or translucent plastic that can be illuminated when light is directed thereto. As shown in FIG. 7 an optical fiber or light pipe 31 can transmit light from light source 32 to the layer or sheet of material 30. In an alternative embodiment the device can contain or be coupled to a light source and a battery for powering the light source or can be plugged into an electrical receptacle for powering a light source container within the device.

The multi-purpose device of the present invention provides many diverse functions as will not be described. The rigid projection(s) 3 that extends outward from the smaller portion 2 can be used to cut tape on packages or cut tape or heat sealed or shrink wrap material that might be provided around the a cap on a container for purposes of safety or tamper-proof security. The small rigid prying projection(s) 4 that extends outward from the smaller portion 2 can be used to pry closures from containers. In order to pry and remove a closure from a container, the prying structure(s) 4 of the multi-purpose device is inserted against a side of the container just below the lower edge of the closure. To remove the closure the opposite end of the multi-purpose device is lifted up so that the distal end of the prying structure(s) 4 pivots against the side of the container causing the prying structure(s) 4 to lift the lower edge of the closure upward and remove the closure.

The narrow, curved structure 5 that extends from the main body portion and includes the hook 6 formed at or near the end thereof can be used to pierce or puncture items like the foil or plastic seals that are provided over the tops of medicine containers (beneath the lids or caps). The narrow, curved structure _ that extends from the main body portion and includes the hook 6 can also be used to hook and pull objects such as pop-top openers, pull and tear container openers, cotton packing or stuffing in medicine containers and/or foil covers on foil or blister pack medicines.

The area or central area 8 can be used to display a photograph, drawing or some other graphical or textural material or can receive an attachment such as a pill management attachment 23 that includes variously sized pockets 24 for receiving pills pushed through the foil backing of foil blister pack medicine packs and/or splitting pills. Other types of attachments include a compartmented daily pill box can be coupled to the device in a similar manner as the pill management attachment noted above. Other types of attachments include a pad of paper, a dry erasable white board, a timer, or an alarm.

The bottom or underside of the multi-purpose device having the layer or sheet or pad of a non-rigid or resilient material such as a rubber material 12 can used to twist a cap or lid off a container by pressing the multi-purpose device against a cap of lid of a container and rotating the device and lid or cap relative to the container. In the case of press and turn child safety caps or lids, the device of the present invention allows for simultaneously pressing and rotating of a container cap or lid relative to the container.

The embodiment of the device that includes the layer or sheet of material 30 that can be illuminated when light is directed thereto can be coupled, e.g. plugged into a light emanating or generating source 32 to illuminate the a layer or sheet of material 30 can serve as a night light or otherwise illuminate a photograph, drawing or some other graphical or textural material provided on or beneath the layer or sheet of material 30.

The various parts of the multi-purpose device of the present invention can be integrally molded from a suitable rigid plastic material or case from a metal or metal alloy.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above and as set forth in the annexed claims.

What is claimed is:

1. A multi-purpose device for opening the closures of a variety of containers which comprises:
a main body that includes a substantially flat top surface and a substantially flat bottom surface;
a peripheral wall extending downward from the substantially bottom surface of the main body;
an elastomeric sheet attached to the substantially bottom surface of the main body; and
a display area centrally located on the flat top surface of the main body for receiving printed material for display purposes, said display area having a peripheral upstanding rim.

2. A multi-purpose device for opening the closures of a variety of containers according to claim 1, further comprising a smaller portion attached to the main body portion, which smaller portion is substantially coplanar with the main body portion and includes at least one small rigid projection.

3. A multi-purpose for opening the closures of a variety of containers according to claim 1, wherein the at least one small prying projection comprises two small rigid projections.

4. A multi-purpose device for opening the closures of a variety of containers according to claim 3, further comprising at least one prying projection located between the two small rigid projections.

5. A multi-purpose device for opening the closures of a variety of containers according to claim 2, further comprising a magnet coupled to the small portion for attaching the multi-purpose closure opening device to a metal surface.

6. A multi-purpose device for opening the closures of a variety of containers according to claim 1, further comprising a narrow curved structure that extends from the main body portion.

7. A multi-purpose closure opening device for opening the closures of a variety of containers according to claim 6, the narrow curved portion includes a hooked spaced end.

8. A multi-purpose device for opening the closures of a variety of containers according to claim 2, wherein the device is configured to be in the general shape of an animal.

9. A multi-purpose device for opening the closures of a variety of containers according to claim 1, further comprising an attachment that is coupled to the main body so as to extend outward from the top surface thereof.

10. A multi-purpose device for opening the closures of a variety of containers according to claim 9, wherein the attachment comprises pill management attachment that includes variously sized pockets for receiving pills pushed through the foil backing of foil blister pack medicine packs.

11. A multi-purpose device for opening the closures of a variety of containers according to claim 9, wherein the attachment comprises pill management attachment that includes at least one pocket that is configured to split pills therein.

12. A multi-purpose device for opening the closures of a variety of containers according to claim 9, wherein the attachment comprises a pad of paper, a dry erasable white board, a timer, a pill carrier or an alarm.

13. A multi-purpose device for opening the closures of a variety of containers according to claim 1, further comprising a light transmitting material coupled to top surface of the main body.

14. A multi-purpose device for opening the closures of a variety of containers which comprises:
a main body that includes a substantially flat top surface and a substantially flat bottom surface;
a peripheral wall extending downward from the substantially bottom surface of the main body;
an elastomeric sheet attached to the substantially bottom surface of the main body;
a display area centrally located on the flat top surface of the main body for receiving printed material for display purposes, said display area having a peripheral upstanding rim; and
a smaller portion attached to the main body portion, which smaller portion is substantially coplanar with the main body portion and includes at least one small rigid projection.

15. A multi-purpose device for opening the closures of a variety of containers according to claim 14, wherein the device is configured to be in the general shape of an animal, with the main body configured to be the body of an animal and the smaller portion configured to be the head of an animal.

16. A multi-purpose for opening the closures of a variety of containers according to claim 14, wherein the at least one small prying projection comprises two small rigid projections.

17. A multi-purpose device for opening the closures of a variety of containers according to claim 14, further comprising at least one prying projection located between the two small rigid projections.

18. A multi-purpose device for opening the closures of a variety of containers according to claim 14, further comprising a magnet coupled to the small portion for attaching the multi-purpose closure opening device to a metal surface.

19. A multi-purpose device for opening the closures of a variety of containers according to claim 14, further comprising a narrow curved structure that extends from the main body portion.

20. A multi-purpose device for opening the closures of a variety of containers according to claim 14, further comprising an attachment that is coupled to the main body so as to extend outward from the top surface thereof.
